(19) United States
(12) Patent Application Publication
(10) Pub. No.: US 2025/0371767 A1
(43) Pub. Date: Dec. 4, 2025

(54) METHOD, APPARATUS, ELECTRONIC DEVICE AND STORAGE MEDIUM FOR AVATAR PUBLISHING

(71) Applicant: Beijing Zitiao Network Technology Co., Ltd., Beijing (CN)

(72) Inventors: Zhimiao HE, Beijing (CN); Zhehao YOU, Beijing (CN); Yuze SUN, Beijing (CN); Weiyi CHANG, Beijing (CN); Huiru YANG, Beijing (CN); Jianbo YAN, Beijing (CN); Zebin HONG, Beijing (CN)

(21) Appl. No.: 18/877,984

(22) PCT Filed: Jun. 21, 2023
(86) PCT No.: PCT/CN2023/101643

§ 371 Date: Dec. 20, 2024

(30) Foreign Application Priority Data
Jun. 22, 2022 (CN) 202210715941.8

(51) Int. Cl. G06T 11/60; G06F 16/958

(52) U.S. Cl. CPC G06T 11/60; G06F 16/958; G06T 2200/24

(57) ABSTRACT

The embodiments of the disclosure provide a method, an apparatus, an electronic device and a storage medium for publishing a virtual image. The method includes: receiving an avatar creation operation on a preset page, the preset page displaying a target object and a user identifier of at least one associated user of a current user; in response to the avatar creation operation, obtaining a first avatar and a state of a target status identifier corresponding to the first avatar; receiving an avatar publishing operation for the first avatar; and in response to the avatar publishing operation, publishing the first avatar performing a target association action, wherein the target association action is an association action of the state of the target status identifier corresponding to the first avatar.

### CROSS-REFERENCE TO RELATED APPLICATIONS

The application is a national stage application based on International Application No. PCT/CN2023/101643, filed on Jun. 21, 2023, which claims priority to Chinese Patent Application No. 202210715941.8, filed before the Chinese Patent Office on Jun. 22, 2022, the contents of which are hereby incorporated by refence in their entireties.

### FIELD

The embodiments of the disclosure relate to the technical field of computers, in particular to a method, an apparatus, an electronic device and a storage medium for avatar publishing.

### BACKGROUND

At present, in some applications, a user may create an avatar in his personal homepage. However, the creation of the avatar in the related art and the created avatar are relatively single, and cannot meet the needs of the user.

### SUMMARY

The embodiments of the disclosure provide a method, an apparatus, an electronic device and a storage medium for avatar publishing.

According to a first aspect, an embodiment of the disclosure provides a method of publishing an avatar, including:
receiving an avatar creation operation on a preset page, the preset page displaying a target object and a user identifier of at least one associated user of a current user;
in response to the avatar creation operation, obtaining a first avatar and a state of a target status identifier corresponding to the first avatar;
receiving an avatar publishing operation for the first avatar; and
in response to the avatar publishing operation, publishing the first avatar performing a target association action, wherein the target association action is an association action of the state of the target status identifier corresponding to the first avatar;

According to a second aspect, an embodiment of the disclosure further provides an apparatus for avatar publishing, including:
a first receiving module, configured to receive an avatar creation operation on a preset page, the preset page displaying a target object and a user identifier of at least one associated user of a current user;
an obtaining module, configured to in response to the avatar creation operation, obtain a first avatar and a state of a target status identifier corresponding to the first avatar;
a second receiving module, configured to receive an avatar publishing operation of the first avatar; and
a publishing module, configured to in response to the avatar publishing operation, publish the first avatar performing a target association action, wherein the target association action is an association action of the state of the target status identifier corresponding to the first avatar.

According to a third aspect, an embodiment of the disclosure further provides an electronic device, including:
one or more processors;
a memory is configured to store one or more programs, and when the one or more programs are executed by the one or more processors, the one or more processors implement the method of publishing an avatar according to an embodiment of the disclosure.

In a fourth aspect, an embodiment of the disclosure further provides a computer-readable storage medium having a computer program stored thereon, the program, when executed by a processor, implements the method of publishing an avatar according to the embodiments of the disclosure.

According to a fifth aspect, an embodiment of the disclosure further provides a computer program product, when the computer program product is executed by a computer, the computer implements the method of publishing an avatar according to an embodiment of the disclosure.

### BRIEF DESCRIPTION OF DRAWINGS

The above and other features, advantages, and aspects of various embodiments of the disclosure will become more apparent from the following detailed description taken in conjunction with the accompanying drawings. Throughout the drawings, the same or similar reference numbers refer to the same or similar elements. It should be understood that the drawings are schematic, and components and elements are not necessarily drawn to scale.

FIG. 1 is a schematic flowchart of a method of publishing an avatar according to an embodiment of the disclosure;

FIG. 2 is a schematic flowchart of another method of publishing an avatar according to an embodiment of the disclosure;

FIG. 3 is a schematic diagram of displaying a status setting page according to an embodiment of the disclosure;

FIG. 4 is a schematic diagram of displaying an avatar setting page according to an embodiment of the disclosure;

FIG. 5 is a schematic diagram of a preview page according to an embodiment of the disclosure;

FIG. 6 is a structural block diagram of an apparatus for publishing an avatar according to an embodiment of the disclosure;

FIG. 7 is a schematic structural diagram of an electronic device according to an embodiment of the disclosure.

### DETAILED DESCRIPTION

Embodiments of the disclosure will be described below with reference to the accompanying drawings. While certain embodiments of the disclosure are shown in the drawings, it is to be understood that the disclosure may be implemented in various forms, providing these embodiments for a more thorough and complete understanding of the disclosure. It should be understood that the drawings and embodiments of the disclosure are for exemplary purposes only.

It should be understood that the steps recited in the method embodiments of the disclosure may be performed in different orders, and/or in parallel. Further, the method embodiments may include additional steps and/or omit performing the illustrated steps.

As used herein, the term “comprising” and deformation thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that concepts such as “first” and “second” mentioned in the disclosure are merely used to distinguish different apparatuses, modules, or units.

It should be noted that the modification of “a” and “a plurality” mentioned in the disclosure is illustrative, and those skilled in the art should understand that “one or more” should be understood unless the context clearly indicates otherwise.

The names of messages or information interaction between multiple devices in embodiments of the disclosure are for illustrative purposes only.

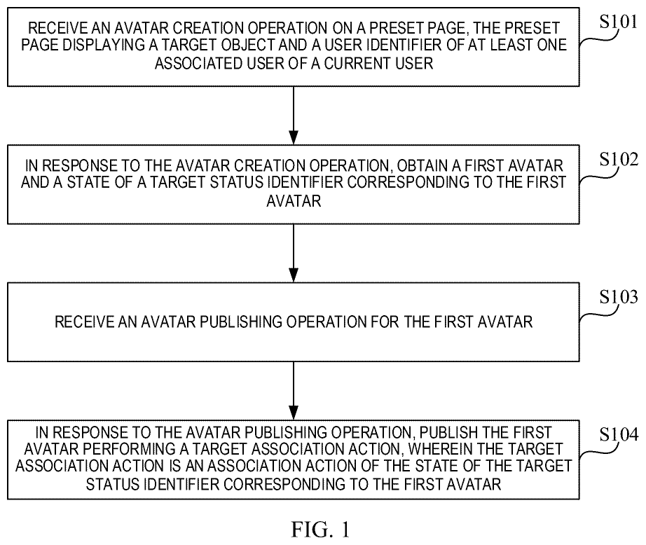

FIG. 1 is a schematic flowchart of a method of publishing an avatar according to an embodiment of the disclosure. The method may be performed by an apparatus for avatar publishing, wherein the apparatus may be implemented by software and/or hardware, may be configured in an electronic device, for example, may be configured in a mobile phone or a tablet computer. The method of publishing an avatar provided by the embodiment of the disclosure is suitable for creating a scene of an avatar associated with the status of the current user. As shown in FIG. 1, the method of publishing an avatar provided in this embodiment may include the following steps.
S101: receive an avatar creation operation on a preset page, the preset page displaying a target object and a user identifier of at least one associated user of a current user.

The preset page may be a page displaying a target object and a user identifier of at least one associated user of the current user, and the preset page may be, for example, a message list page of the current user, an associated user list page (for example, a friend list page or a follower list page), and the like.

The user identifier may be used to identify a corresponding user, and may include a profile picture and/or a nickname of the corresponding user. The profile picture may be a profile picture displayed with an avatar or a profile picture displayed with a non-avatar. The avatar may be set by a user corresponding to the profile picture. Correspondingly, the user identifier of the associated user may include a second target profile picture displayed with a second avatar or a third target profile picture displayed with a non-avatar, and the second avatar is an avatar set by the associated user. The second avatar may be understood as the avatar set by the associated user of the current user. The second target profile picture may be a profile picture of an associated user of the current user that is displayed in an avatar; and the third target profile picture may be profile picture of an associated use of the current user that is displayed with a non-avatar.

The avatar creation operation may be understood as an operation of creating an avatar. The target object may be an object used to trigger display of the avatar attribute setting interface for the current user to create or set the avatar, which may be displayed in the preset page in a form of a control or a non-control, for example, the target object may be a user identifier of the current user, for example, a profile picture of the current user.

In an embodiment, the electronic device displays the preset page, and displays the target object and the user identifier of the at least one associated user of the current user in the preset page. When the current user wants to create the avatar, the avatar creation operation may be performed in the preset page. Correspondingly, the electronic device may receive the avatar creation operation performed by the current user.

When the profile picture (including the profile picture of the current user and/or the profile picture of the associated user of the current user) is displayed in the preset page, the profile picture displayed with the avatar and the profile picture displayed with the non-avatar may have the same or different display sizes. Optionally, in the preset page, a display size of the profile picture displayed with the avatar is different from a display size of the profile picture displayed with the non-avatar, wherein the avatar includes the first avatar or the second avatar. For example, the display size of the profile picture displayed with the avatar may be greater than the display size of the profile picture displayed with the non-avatar, so that the user views the avatar in the profile picture.
S102: in response to the avatar creation operation, obtain a first avatar and a state of a target status identifier corresponding to the first avatar.

The first avatar may be understood as the avatar created by the current user. The target status identifier may be a status identifier corresponding to the first avatar. The status identifier may be understood as an identifier of a status, and different status identifiers are used to identify different status, and the status may be, for example, happy, difficult, like or annoying and the like. The state of the status identifier corresponding to the avatar may include whether the status identifier corresponding to the avatar exists, and when the avatar has a corresponding status identifier, the state of the status identifier corresponding to the avatar may further include the status identifier corresponding to the avatar.

In this embodiment, the avatar may or may not have a corresponding status identifier. Therefore, when the avatar creation operation of the current user in the preset page is received, the first avatar created by the current user and the state of the target status identifier corresponding to the first avatar may be obtained. For example, when the avatar does not have a corresponding status identifier, the state of the target status identifier may be set to a preset parameter.
S103: receive an avatar publishing operation for the first avatar.

In this embodiment, when the current user wants to publish the first avatar created by the current user, the avatar publishing operation for the first avatar may be performed. Therefore, the electronic device may receive the avatar publishing operation performed by the current user. The avatar publishing operation may be understood as a triggering operation for indicating to publish the first avatar, for example, triggering an operation of a publishing control corresponding to the first avatar.
S104: in response to the avatar publishing operation, publish the first avatar performing a target association action, wherein the target association action is an association action of the state of the target status identifier corresponding to the first avatar.

The target association action is an association action of a state of the target status identifier.

In this embodiment, the states of different status identifiers may have different association actions, and optionally, the status corresponding to different status identifiers may also have different association actions. For example, the state of the status identifier may include a state that does not have a corresponding status identifier and a state that has a corresponding status identifier, a state that does not have a corresponding status identifier and a state that has a status identifier may have different associated actions, and when in a state that has a corresponding status identifier, if the corresponding status identifiers are different, the associated actions for the state that has the corresponding status identifier may be different. Therefore, different actions can be controlled to perform on the avatar based on different states of the corresponding status identifiers and/or different corresponding status identifiers, the status of the creator of the avatar is represented by actions performed by the avatar, diversified avatar creation and control manners can be provided for the user, and richer functions are provided for the avatar. When it is in a state that does not have a corresponding status identifier, the avatar may be controlled to perform a default action.

In an embodiment, when the avatar publishing operation for the first avatar is received, a target association action corresponding to the state of the target status identifier may be determined, the first avatar is controlled to perform the target association action, and the first avatar performing the target association action is published.

In this embodiment, when the first avatar performing the target association action is published, the first avatar that performs the target association action published by the current user may be displayed in the preset page. For example, the preset page is displayed, and the first avatar performing the target association action is displayed on the upper layer of the preset page, or the first avatar performing the target association action is displayed at a preset position in the preset page, and so on, so that the current user views the first avatar published by the current user. The set position may be a set region in the preset page; or may be a display position of a set page component in the preset page, for example, may display the first avatar published by the current user in the target object of the preset page, and in this case, optionally, the publishing the first avatar that performs the target association action includes: displaying the first avatar published by the user in the target object of the preset page.

In this embodiment, when the first avatar performing the target association action is published, the first avatar published by the current user may be used as the profile picture of the current user.

In an exemplary implementation, the publishing the first avatar that performs the target association action includes: updating the profile picture of the current user to the first target profile picture displayed with the first avatar. For example, when the first avatar performing the target association action is published, the profile picture of the current user may be automatically updated to profile picture displayed by the first avatar that performs the target association action, that is, when the avatar publishing operation is received, the profile picture of the current user is updated to profile picture displayed with the first avatar.

In another exemplary implementation, the method of publishing an avatar provided in this embodiment may further include: in response to an updating operation for the first avatar, updating the profile picture of the current user to the first target profile picture displayed with the first avatar. For example, when publishing the first avatar that performs the target association action, the profile picture of the current user may not be automatically updated to the profile picture displayed by the first avatar that performs the target association action in response to the received avatar publishing operation, but when the update operation for the first avatar is received, the profile picture of the current user is updated to the profile picture displayed by the first avatar that performs the target association action. Here, the update operation for the first avatar may be understood as a trigger operation for instructing to update the profile picture of the current user to the first avatar that performs the target association action.

The first target profile picture may be understood as a profile picture displayed by the first avatar that performs the target association action, and may be a static profile picture or a dynamic profile picture, that is, the target association action performed by the first avatar may be a static action (that is, the first avatar presents a pose and remains inactive) or a dynamic action. For example, when the avatar (including the first avatar or the second avatar) does not have a corresponding status identifier, the associated action may be a static action, and accordingly, the first avatar may maintain presenting a gesture corresponding to the associated action; when the avatar has a corresponding status identifier, the associated action may be a dynamic action, and accordingly, the first avatar may cyclically perform the dynamic action.

In an implementation, the method of publishing an avatar provided in this embodiment may further include: in response to a selection operation for a profile picture of the current user, updating the profile picture of the current user to a target profile picture, wherein the profile picture includes a first target profile picture displayed with the first avatar or a second target profile picture displayed with a non-avatar.

The selection operation for the profile picture of the current user may be understood as selecting a profile picture as the trigger operation of the profile picture of the current user. The target profile picture is a profile picture corresponding to the selection operation, for example, a profile picture selected by the selection operation, which may be a profile picture displayed with an avatar or a profile picture displayed with a non-avatar. The second target profile picture may be understood as a profile picture that is set or selected by the current user and is displayed with a non-avatar.

In the foregoing implementation, regardless of whether the profile picture of the current user is updated to the first target profile picture displayed with the first avatar when publishing the first avatar performing a target association action, and regardless of whether the profile picture of the current user is the first target profile picture displayed with the first avatar at the current moment, the profile picture corresponding to the selection operation may be used as the profile picture of the current user when the selection operation for the profile picture for the current user is received, for example, when the target profile picture is the first target profile picture displayed with the first avatar, the first target profile picture is used as the profile picture of the current user; when the target profile picture is the second target profile picture displayed with the non-avatar, the second target profile picture is user as the profile picture of the current user.

According to the method of publishing an avatar provided by the embodiment, receiving an avatar creation operation on a preset page, the preset page displaying a target object and a user identifier of at least one associated user of a current user; in response to the avatar creation operation, obtaining a first avatar and a state of a target status identifier corresponding to the first avatar; receiving an avatar publishing operation for the first avatar; and in response to the avatar publishing operation, publishing the first avatar performing a target association action, wherein the target association action is an association action of the state of the target status identifier corresponding to the first avatar. By adopting the foregoing method in the embodiment, different actions can be controlled to perform on the avatar based on different states of the corresponding status identifiers and/or different corresponding status identifiers, the status of the creator of the avatar is represented by actions performed by the avatar, diversified avatar creation and control manners can be provided for the user, and richer functions are provided for the avatar.

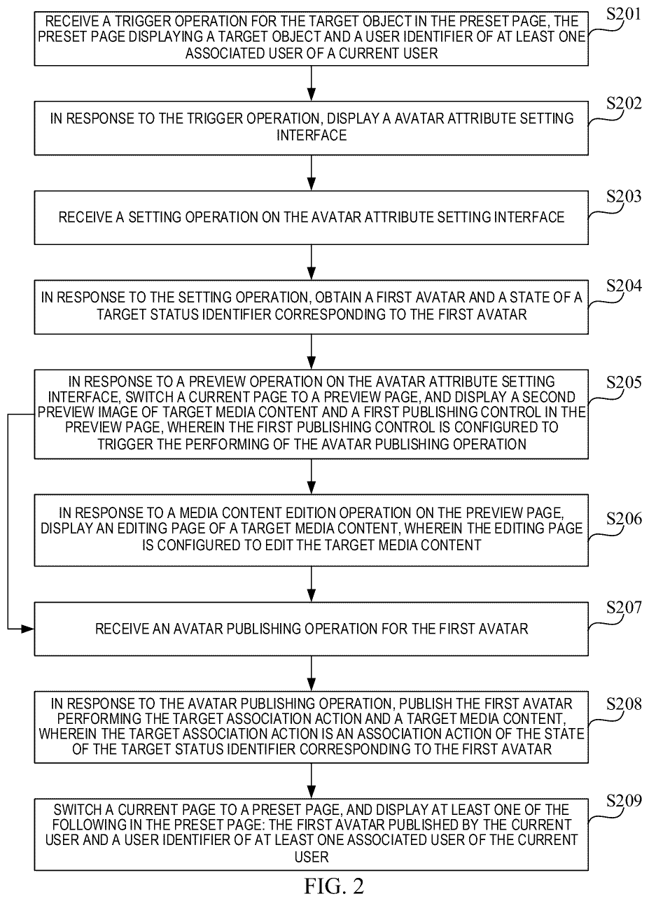

FIG. 2 is a schematic flowchart of another method of publishing an avatar according to an embodiment of the disclosure. The solution in the embodiment may be combined with one or more optional solutions in the foregoing embodiments. Optionally, the receiving an avatar creation operation on a preset page includes: receiving a trigger operation on the target object in the preset page; in response to the trigger operation, displaying an avatar attribute setting interface; and receiving a setting operation on the avatar attribute setting interface.

Optionally, the method of publishing an avatar provided in the embodiment further includes: in response to a preview operation on the avatar attribute setting interface, switching a current page to a preview page, and displaying a second preview picture of target media content and a first publishing control in the preview page, wherein the first publishing control is configured to trigger the performing of the avatar publishing operation.

Optionally, after the displaying the second preview picture of the target media content and the first publishing control in the preview page, the method further includes: in response to a media content edition operation on the preview page, displaying an editing page of a target media content, wherein the editing page is configured to edit the target media content.

Optionally, the in response to the avatar publishing operation, publishing the first avatar performing a target association action includes: in response to the avatar publishing operation, publishing a target media content and the first avatar performing the target association action.

Optionally, after the publishing the first avatar performing a target association action, the method further: switching a current page to a preset page, and displaying at least one of the following in the preset page: the first avatar published by the current user and a profile picture of at least one associated user of the current user, wherein the profile picture of the associated user includes a second target profile picture displayed with a second avatar or a third target profile picture avatar displayed with a non-avatar, and the second avatar is an avatar set by associated user.

Correspondingly, as shown in FIG. 2, the method of publishing an avatar provided in the embodiment may include the following steps.
S201: receive a trigger operation on a target object of a preset page, the preset page displaying a target object and a user identifier of at least one associated user of the current user.

In the embodiment, the current user may instruct the electronic device to display the avatar attribute setting interface by triggering the target object displayed in the preset page, so as to create the first avatar in the avatar attribute setting interface.
S202: display an avatar attribute setting interface in response to the trigger operation.

In an embodiment, when the trigger operation on the target object of the preset page is received, the avatar attribute setting interface may be displayed, for example, the status setting page and/or the avatar setting interface are displayed, so that the current user sets the state and/or avatar information of the status identifier corresponding to the first avatar to be created.
S203: receive a setting operation on the avatar attribute setting interface.

In the embodiment, the current user may perform a setting operation in the avatar attribute setting interface to set state and/or avatar information of the status identifier corresponding to the first avatar to be created. Therefore, the electronic device may receive a setting operation performed by the current user in the avatar attribute setting interface. The setting operation may be an operation of setting the state and/or the avatar information of the status identifier corresponding to the avatar, for example, selecting a status identifier as an operation for the status identifier corresponding to the first avatar, or selecting appearance information/clothing information as an operation for the appearance information/clothing information of the first avatar, and the like.

In an implementation, the state of the target status identifier includes whether a target status identifier in a selected state exists, and the displaying an avatar attribute setting interface includes: displaying a status setting page of the first avatar, wherein the status setting page includes a status identifier display area, and at least one status identifier is displayed in the status identifier display area; the receiving a setting operation on the avatar attribute setting interface includes: receiving a first setting operation for a target status identifier in the at least one status identifier, wherein the first setting operation is used to indicate to display the target status identifier as being in the selected state.

The first setting operation may be understood as a trigger operation for setting a status corresponding to a status identifier as a status corresponding to the first avatar, that is, a trigger operation for indicating that a certain status identifier is displayed as being in the selected state, and may be an operation of triggering the status identifier displayed in the status identifier display area.

In the foregoing implementation, the current user may set the status identifier corresponding to the first avatar through the status setting page, and then set the action performed by the first avatar.

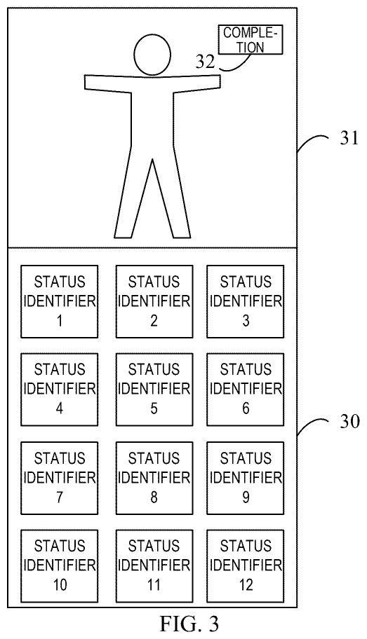

In an embodiment, the electronic device may display a status setting page of the first avatar, and display at least one status identifier that can be selected by the current user in the status identifier display area 30 of the status setting page, as shown in FIG. 3. Therefore, when the current user wants to select a status identifier as the status identifier corresponding to the first avatar to be created, the current user may trigger to select the status identifier. Correspondingly, when detecting that the current user triggers a status identifier, the electronic device may display the status identifier as being in a selected state (for example, status identifier 2 in FIG. 3), and use the status identifier in the selected state as the status identifier corresponding to the first avatar.

With continued reference to FIG. 3, in the embodiment, the status setting page may further include an action preview area 31, and the action preview area 31 is configured to display a first preview picture of the target association action. Therefore, after the current user selects a status identifier, an association action of the status corresponding to the status identifier may be displayed in the action preview area 31, for example, a preview picture of the first avatar for performing the association action is displayed in the action preview area 31 for the current user to preview the action performed by the first avatar. The first preview image may be understood as a preview image of an association action of a status corresponding to the status identifier.

In an implementation, the displaying an avatar attribute setting interface includes: displaying an avatar setting page; the receiving a setting operation on the avatar attribute setting interface includes: receiving a second setting operation on the avatar setting page, where the second setting operation is used to indicate at least one of appearance information or clothing information of the first avatar.

The second setting operation may be understood as an operation of setting at least one of avatar information and clothing information for the first avatar. The avatar information may be understood as appearance information of the first avatar, for example, a shape (for example, a color, a shape, and/or a size) of each part of the first avatar. The clothing information may be understood as information of clothing worn by the first avatar.

In the above embodiment, the current user may set at least one of the avatar information and the clothing information of the first avatar through the avatar setting page.

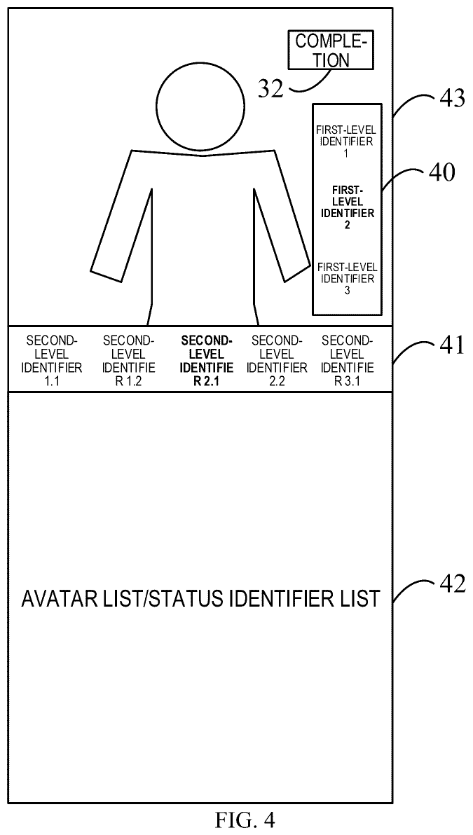

In an embodiment, the electronic device may display an avatar setting page of the first avatar, and display, in the avatar setting page, a list of avatar identifiers and/or clothing identifiers that may be selected by the current user, as shown in FIG. 4. Therefore, when the current user wants to select the appearance/clothing corresponding to a certain appearance identifier/clothing identifier as the appearance/clothing of the first avatar to be created, the current user may trigger selection of the appearance identifier/clothing identifier. Correspondingly, when detecting that the current user triggers a certain avatar identifier/clothing identifier, the electronic device may display the avatar identifier/clothing identifier as being in a selected state, and control the first avatar to display an appearance corresponding to the appearance identifier in the selected state, and/or a clothing corresponding to the clothing identifier in the selected state.

In the embodiment, as shown in FIG. 4, the avatar setting page may include a first area 40, a second area 41, and a third area 42, the first area 40 may be configured to display at least two first-level identifiers, and the at least two first-level identifiers may include first-level avatar identifiers and first-level status setting identifiers; the second area 41 may be configured to display second-level identifier of the at least two first-level identifiers (as shown in FIG. 4, a second-level identifier 1.1 and a second-level identifier 1.2 displayed in the second area 41 are second-level identifiers of first-level identifier 1 displayed in the first area 40, second-level identifier 2.1 and second-level identifier 2.2 displayed in the second area 41 are second-level identifiers of first-level identifier 2 displayed in the first area 40, second-level identifier 3.1 displayed in the second areas 41 is second-level identifier of first-level identifier 3 displayed in the first area 40), second-level identifiers of the at least two first-level identifiers may include second-level avatar identifiers and second-level status setting identifiers, and the third area 42 may be configured to display avatar list and a status identifier list. The avatar list may include a plurality of avatars (for example, mouth, ears, eyes, arms or clothing) that may be selected by the user; and the status identifier list may include a plurality of status identifier that may be selected by the user.

In addition, as shown in FIG. 4, the avatar setting page may further be provided with an avatar preview area 43 for displaying the avatar preview image of the first avatar, so that the current user previews the first avatar. When there is a tertiary identifier, a fourth area may also be provided in the avatar setting page, and a tertiary identifier of one or more second-level identifiers is displayed through the fourth area.

In an implementation, after the displaying the avatar setting page, the method further includes: in response to a triggering operation for the target second-level status setting identifier displayed in the second area, displaying a status identifier list corresponding to a target second-level status setting identifier in the third area, and displaying the target second-level status setting identifier and the first-level status setting identifier corresponding to the target second-level status setting identifier as being in a selected state; or in response to a trigger operation for the target second-level avatar identifier displayed in the second area, displaying an avatar list corresponding to a target second-level avatar identifier in the third area, and displaying the target second-level avatar identifier and the first-level avatar identifier corresponding to the target second-level avatar identifier as being in the selected state.

The target second-level status setting identifier may be understood as a second-level status setting identifier triggered by the current user. The target second-level avatar identifier may be understood as a second-level avatar identifier triggered by the current user.

In the foregoing implementation, the current user may instruct the electronic device to display the status identifier list or the avatar list corresponding to the second-level identifier in the third area by triggering a second-level identifier displayed in the second area.

In an embodiment, when the current user wants to view a certain second-level identifier (for example, a second-level status setting identifier or a second-level avatar identifier), the second-level identifier may be triggered in the second area, for example, clicking the second-level identifier displayed in the second area. Correspondingly, when detecting that the current user triggers a certain second-level identifier, the electronic device may display, in the third area, the status identifier list corresponding to the second-level identifier (for the case where the second-level identifier is the second-level status setting identifier) or the avatar list (for the case where the second-level identifier is the second-level avatar identifier), and display the second-level identifier and the first-level identifier corresponding to the second-level identifier as being a selected state.

In an implementation, after the displaying an avatar setting page, the method further includes: in response to the target sliding operation within the second area or the third area, switching an initial list displayed in the third area to a target list corresponding to a target sliding operation, and displaying a second-level identifier and a first-level identifier corresponding to the target list as being in a selected state, where the initial list is the status identifier list, and the target list is the avatar list; or the initial list is the avatar list, and the target list is the status identifier lists.

The target sliding operation may be an operation of sliding in a preset direction, for example, a transverse sliding operation or a vertical sliding operation, and the following uses the target sliding operation as a transverse sliding operation as an example for description. The initial list may be understood as a list displayed in the third area before the target sliding operation is received, which may be a status identifier list or an avatar list; the target list may be a list indicated by the target sliding operation, for example, an avatar list or a status identifier list.

In the foregoing implementation, the current user may switch the list displayed in the third area by performing the target sliding operation in the second area or the third area, for example, switch the status identifier list displayed in the third area to the avatar list, or switch the avatar list displayed in the third area to the status identifier list.

For example, when it is detected that the current user performs the target sliding operation in the second area, the second-level identifiers displayed in the second area may be controlled to move, and during the performing of the target sliding operation and/or after the performing of the target sliding operation is finished, the second-level identifier at the preset location (for example, the center location of the second area) located in the second area is determined, the list corresponding to the second-level identifier is displayed in the third area, and the second-level identifier and the first-level identifier corresponding to the second-level identifier are displayed as being in a selected state.

When it is detected that the current user performs the target sliding operation in the third area, the list corresponding to the sliding direction of the target sliding operation in the second area and adjacent to the second-level identifier corresponding to the initial list may be used as the target list based on the arrangement sequence of the second-level identifiers in the second area, the target list is displayed in the third area, and the second-level identifier and the first-level identifier corresponding to the target list are displayed as being in a selected state.

In the embodiment, a correspondence between each list (for example, an avatar list or a status identifier list) and each second-level identifier (for example, a second-level avatar identifier or a second-level status setting identifier) and a correspondence between each second-level identifier and each first-level identifier (for example, a first-level avatar identifier or a first-level status setting identifier) may be preset and recorded, for example, a second-level identifier corresponding to each list and a first-level identifier to which each second-level identifier belongs may be pre-recorded in the configuration file.

When the avatar setting page is displayed, the change state of each level menu is detected in real time, and whether the change of the level menu will cause changes of other associated hierarchical menus is determined based on the configuration file above described, so as to change the corresponding associated hierarchical menu. Exemplarily, when the list displayed in the third area is switched, the second-level identifier corresponding to the list displayed in the switched third area may be determined based on the correspondence, the second-level identifier is switched from the unselected state to the selected state, and the other second-level identifiers in the second area other than the second-level identifier are displayed as being an unselected state. When it is detected that a second-level identifier is switched from an unselected state to a selected state, a first-level identifier corresponding to the second-level identifier may be determined based on the correspondence, whether the first-level identifier is in a selected state is determined, and if the first-level identifier is in the selected state, the first-level identifier is maintained to be displayed as being in a selected state; if the first-level identifier is not in the selected state, the first-level identifier is switched from an unselected state to a selected state, and other first-level identifiers in the first area other than the first-level identifier are displayed as being in an unselected state.

In addition, when the current user triggers a first-level identifier in the first area, the first-level identifier triggered by the current user may be displayed as being in a selected state, and other first-level identifiers in the first area other than the first-level identifier may be displayed as being in an unselected state. In addition, when it is detected that a first-level identifier is switched from an unselected state to a selected state, second-level identifiers corresponding to the first-level identifiers may be determined based on the foregoing correspondence, one of the determined second-level identifiers is switched from an unselected state to a selected state, other second-level identifiers in the second area other than the second-level identifier is displayed as being in an unselected state, and a list corresponding to the second-level identifier in the selected state is displayed in the third area.

Taking FIG. 4 as an example, the user may perform a sliding operation in the second area to switch the second-level identifier, for example, switch from the second-level identifier 1.2 to the second-level identifier 2.1 through a sliding operation, and correspondingly, the selected first-level identifier automatically changes from the second-level identifier 1 to the second-level identifier 2. In addition, performing the sliding switching operation on the third region may also implement automatic switching between the corresponding second-level identifier and the first-level identifier.

In the embodiment, the second-level identifiers corresponding to different first-level identifiers are displayed in the second area, so that the user can directly view the second-level identifier under each first-level identifier in the second area, and view the corresponding list by triggering the corresponding second-level identifier, and the second-level identifier under the first-level identifier do not need to be viewed in a manner of triggering the first-level identifier, so that the operation required by the user to view the second-level identifiers under different first-level identifiers and the list corresponding to the second-level identifiers under different first-level identifiers can be simplified, thereby the time consumed by the user to create the avatar is simplified and the user experience is improved.
S204: in response to the setting operation, obtain a first avatar and a state of a target status identifier corresponding to the first avatar.

In an embodiment, the first avatar set by the current user in the avatar attribute setting interface and the state of the target status identifier corresponding to the first avatar may be obtained based on the setting operation of the current user.
S205: in response to a preview operation on the avatar attribute setting interface, switch a current page to a preview page, and display a second preview picture of target media content and a first publishing control in the preview page, and performing S206 or S207, where the first publishing control is configured to trigger the performing of the avatar publishing operation.

The preview operation may be a trigger operation for indicating a preview picture for displaying the target media content, for example, a trigger operation for triggering a completion control 32 (as shown in FIG. 3 and FIG. 4) in the avatar attribute setting interface, which may be on a status setting page and/or an avatar setting page. The target media content may be media content including the first avatar, such as a video displaying a picture in which the first avatar performs the target association action. The second preview image may be understood as a preview image of the target media content. The first publishing control may be understood as a control displayed in the preview page of the target media content and used to trigger the performing of the avatar publishing operation for the first avatar.

In the embodiment, during the current user sets the first avatar in the avatar attribute setting interface or after the first avatar is set, the target media content generated by using the first avatar may be previewed by performing the preview operation.

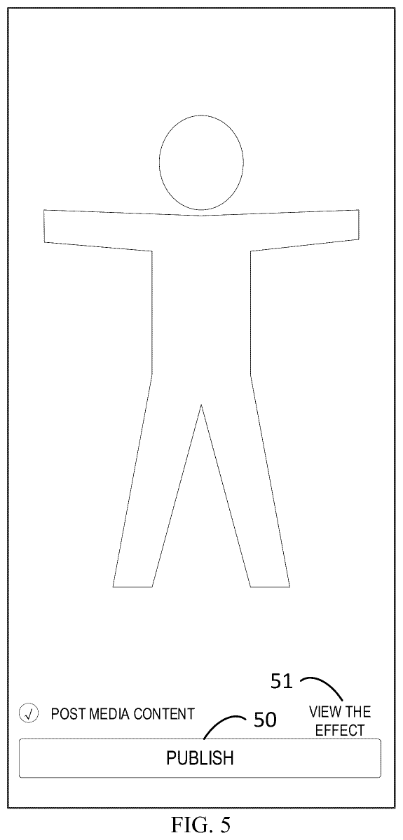

In an embodiment, when the preview operation of the current user in the avatar attribute setting interface is received, the current page may be switched to the preview page, and the second preview image of the target media content and the first publishing control 50 are displayed in the preview page, as shown in FIG. 5. Therefore, the current user may preview the target media content in the preview page, and publishing the first avatar and/or the target media content by triggering the first publish control 50.
S206: in response to a media content edition operation on the preview page, display an editing page of a target media content, wherein the editing page is configured to edit the target media content.

The media content edition operation may be an operation used to indicate an editing page for displaying the target media content, for example, an operation of triggering an editing control displayed in the preview page.

For example, when the current user wants to edit the target media content, the current user may perform a media content edition operation in the preview page, for example, trigger an editing control 51 in the preview page (as shown in FIG. 5). Correspondingly, when detecting that the current user triggers the editing control 51 in the preview page, the electronic device may determine that the media content edition operation is received, and switch the current page from the preview page to the editing page of the target media content in response to the media content edition operation. Therefore, the current page may edit the target media content in the editing page.

Taking editing the background music and/or the picture background color of the target media content as an example, when the target media content is initially generated, for example, before the current user edits the target media content, the background music associated with the first avatar may be used as the background music of the target media content, and/or the background color associated with the first avatar be used as the background color of the target media content. That is, optionally, the background music of the target media content is background music associated with the first avatar, and/or the picture background color of the target media content is background color associated with the first avatar. For example, background music associated with each type of avatar may be preset, or background music associated with each status identifier may be preset as background music associated with the avatar; and/or a background color associated with the first avatar may be determined based on the color of each part of the first avatar or the color of each pixel constituting the picture of the first avatar.

Therefore, when the current user wants to edit the background music and/or the picture background color of the target media content, the current user may perform a media content editing operation to switch to an editing page of the target media content, and edit the target media content in the editing page.

In addition, a second publishing control may be displayed in the editing page, and the second publishing control is configured to trigger the performing of the avatar publishing operation. Therefore, after the target media content is edited in the editing page, the current user may directly trigger the second publishing control displayed in the editing page to perform the avatar publishing operation. The second publishing control may be understood as a control displayed in an editing page of the target media content and used to trigger the performing of the avatar publishing operation for the first avatar.
S207: receive an avatar publishing operation for the first avatar.
S208, in response to the avatar publishing operation, publish a target media content and the first avatar performing the target association action, where the target association action is an association action of a state of a target status identifier corresponding to the first avatar.

In an embodiment, when the avatar publishing operation is received, in addition to the first avatar publishing the target association action, the target media content displaying the picture in which first avatar performs the target association action may be published, to simplify the operation required by the user to post the target media content, and meet the media content publishing requirement of the user.

In the embodiment, the first avatar may be published and the target media content may be posted when the avatar publishing operation for instructing to publishing the first avatar is received, that is, the target media content is posted when the first avatar is published. Alternatively, the target media content is posted, and the first avatar is published when the media content posting operation for instructing to post the target media content is received, that is, the first avatar is published when the target media content is posted, so as to simplify the operations required by the current user to publishing the first avatar and the target media content. And at this point, optionally, the in response to the avatar publishing operation, publishing target media content and the first avatar performing the target association action includes: in response to a media content publishing operation for the first avatar, publishing the target media content and the first avatar performing the target association action, wherein the target media content displays a picture in which the first avatar performs the target association action. Here, the media content publishing operation for the first avatar may be a triggering operation for indicating to post the target media content.

It should be noted that, in the embodiment, when the media content publishing operation for the first avatar is received, only the target media content is posted, and the first avatar is not published, which may be flexibly set as needed.
S209: switch a current page to a preset page, and display at least one of the following in the preset page: the first avatar published by the current user and a user identifier of at least one associated user of the current user.

In an embodiment, after the avatar publishing operation is received, for example, after the at least one of the first avatar and the target media content is published, the current page may be switched to the preset page, and at least one of the following is displayed in the preset page: the first avatar published by the current user and the user identifier of the at least one associated user of the current user.

According to the method of publishing the avatar provided by the embodiment, after the user creates the avatar, the created avatar and the media content including the avatar can be published, that is, the user can complete the creation of the avatar and the publishing of the avatar and the media content in the same operation path, the operation required for creating the avatar and publishing the avatar and the media content can be simplified, and the time consumed by the user to publish the avatar and the media content is shortened.

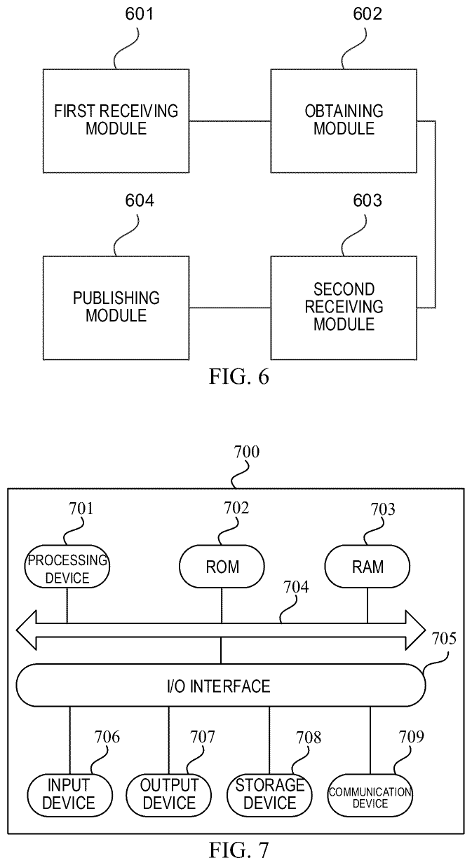

FIG. 6 is a structural block diagram of an apparatus for publishing an avatar according to an embodiment of the disclosure. The apparatus may be implemented by software and/or hardware, and may be configured in an electronic device, for example, may be configured in a mobile phone or a tablet computer, and may publish an avatar by performing a method of publishing an avatar. As shown in FIG. 6, the apparatus for publishing a avatar provided in the embodiment may include: a first receiving module 601, an obtaining module 602, a second receiving module 603, and a publishing module 604, in which
the first receiving module 601 is configured to receive an avatar creation operation on a preset page, the preset page displaying a target object and a user identifier of at least one associated user of a current user;
the obtaining module 602 is configured to in response to the avatar creation operation, obtain a first avatar and a state of a target status identifier corresponding to the first avatar;
the second receiving module 603 is configured to receive an avatar publishing operation for the first avatar;
the publishing module 604 is configured to in response to the avatar publishing operation, publish the first avatar performing a target association action, wherein the target association action is an association action of the state of the target status identifier corresponding to the first avatar.

According to the apparatus for publishing an avatar provided in the embodiment, an avatar creation operation on a preset page is received by a first receiving module, and a target object and a user identifier of at least one associated user of a current user are displayed in the preset page; a first avatar and a state of a target status identifier corresponding to the first avatar is obtained by the obtaining module in response to the avatar creation operation; an avatar publishing operation of the first avatar received by the second receiving module; and a first avatar performing a target association action is published by the publishing module in response to the avatar publishing operation, where the target association action is an association action of the state of the target status identifier corresponding to the first avatar. In the embodiment, by using the foregoing apparatus, different actions can be controlled to perform on the avatar based on different states of the corresponding status identifiers and/or different corresponding status identifiers, the status of the creator of the avatar is represented by actions performed by the avatar, diversified avatar creation and control manners can be provided for the user, and richer functions are provided for the avatar.

In the above solution, the first receiving module 601 may include: a trigger operation receiving unit, configured to receive a trigger operation on a target object of a preset page; a setting interface display unit, configured to display an avatar attribute setting interface in response to the trigger operation; and a setting operation receiving unit, configured to receive a setting operation on the avatar attribute setting interface.

In the foregoing solution, the state of the target status identifier may include whether a target status identifier in a selected state exists, and the setting interface presenting unit may be configured to display the avatar attribute setting interface in the following manner: displaying the status setting page of the first avatar, where the status setting page includes the status identifier display area, and the status identifier display area displays at least one status identifier; and the setting operation receiving unit may be configured to receive a setting operation on the avatar attribute setting interface in the following manner: receiving a first setting operation for the target status identifier in the at least one status identifier, where the first setting operation is used to indicate that the target status identifier is displayed as being in the selected state.

In the foregoing solution, the status setting page may further include an action preview area, and the action preview area may be configured to display a first preview picture of the target association action.

In the above solution, the setting interface display unit may be configured to: display an avatar setting page; the setting operation receiving unit may be configured to receive a setting operation on the avatar attribute setting interface in the following manner: receiving a second setting operation on the avatar setting page, where the second setting operation is used to indicate avatar information of the first avatar, and the avatar information comprises at least one of appearance information or clothing information.

In the foregoing solution, the avatar setting page may comprise a first area, a second area and a third area, the first area may be configured to display at least two first-level identifiers, the at least two first-level identifiers comprise a first-level avatar identifier and a first-level status setting identifier, the second area may be configured to display second-level identifiers of the at least two first-level identifiers, the second-level identifiers of the at least two first-level identifiers may comprise a second-level avatar identifier and a second-level status setting identifier, and the third area may be configured to display an avatar list and a status identifier list.

The apparatus for publishing an avatar provided in the embodiment may further include: a trigger response module, configured to, after the display an avatar setting page, in response to a triggering operation for the target second-level status setting identifier displayed in the second area, display a status identifier list corresponding to a target second-level status setting identifier in the third area, and display the target second-level status setting identifier and the first-level status setting identifier corresponding to the target second-level status setting identifier as being in a selected state; or, in response to a trigger operation for the target second-level avatar identifier displayed in the second area, display an avatar list corresponding to a target second-level avatar identifier in the third area, and display the target second-level avatar identifier and the first-level avatar identifier corresponding to the target second-level avatar identifier as being in the selected state.

Optionally, the apparatus for publishing an avatar provided in the embodiment may further include: a sliding response module, configured to, after the displaying an avatar setting page, in response to the target sliding operation within the second area or the third area, switch an initial list displayed in the third area to a target list corresponding to a target sliding operation, and display a second-level identifier and a first-level identifier corresponding to the target list as being in a selected state, where the initial list is the status identifier list, and the target list is the avatar list; or the initial list is the avatar list, and the target list is the status identifier list.

Optionally, the apparatus for publishing an avatar provided in the embodiment may further include: a preview page display module, configured to, in response to a preview operation on the avatar attribute setting interface, switch a current page to a preview page, and display a second preview picture of target media content and a first publishing control in the preview page, wherein the first publishing control is configured to trigger the performing of the avatar publishing operation.

Optionally, the apparatus for publishing an avatar provided in the embodiment may further include: an editing page display module, configured to after the displaying a second preview picture of target media content and a first publishing control in the preview page, in response to a media content edition operation on the preview page, display an editing page of a target media content, wherein the editing page is configured to edit the target media content.

In the foregoing solution, a second publishing control may be displayed in the editing page, and the second publishing control may be configured to trigger the performing of the avatar publishing operation.

In the foregoing solution, the publishing module 604 may be configured to publish the first avatar that performs the target association action in the following manner: display the first avatar published by the user in the target object of the preset page.

In the foregoing solution, the publishing module 604 may be configured to publish the first avatar that performs the target association action in response to the avatar publishing operation in the following manner: in response to the avatar publishing operation, publish the first avatar performing the target association action and target media content.

In the foregoing solution, the publishing module 604 may be configured to publish the first avatar that perform the target association action and the target media content in response to the avatar publishing operation in the following manner: in response to a media content publishing operation for the first avatar, publish the first avatar performing the target association action and the target media content, wherein the target media content displays a picture in which the first avatar performs the target association action.

In the above solution, the background music of the target media content may be background music associated with the first avatar, and/or a picture background color of the target media content may be a background color associated with the first avatar.

In the foregoing solution, the publishing module 604 may be configured to publish the first avatar that performs the target association action in the following manner: update a profile picture of the current user with a first target profile picture displayed with the first virtual image.

Optionally, the apparatus for publishing an avatar provided in the embodiment may further include: a page switching module, configured to, after the publishing the first avatar that performs the target association action, switch a current page to a preset page, and display at least one of the following in the preset page: the first avatar published by the current user and a user identifier of at least one associated user of the current user.

Optionally, the apparatus for publishing an avatar provided in the embodiment may further include: a first profile picture updating module, configured to, in response to an update operation for the first avatar, update a profile picture of the current user to a first target profile picture displayed with the first avatar.

Optionally, the apparatus for publishing an avatar provided in the embodiment may further include: a second profile picture updating module, configured to, in response to a selection operation for a profile picture of the current user, update a profile picture of the current user to a target profile picture, where the target profile picture includes a first target profile picture displayed with the first avatar or a second target profile picture displayed with a non-avatar.

In the foregoing solution, the user identifier of the associated user may comprise a second target profile picture displayed with the second avatar or a third target profile picture displayed with a non-avatar, and the second avatar may be an avatar set by the associated user.

In the foregoing solution, in the preset page, a display size of a profile picture displayed with an avatar may be different from a display size of a profile picture displayed with a non-avatar, wherein the avatar may comprise the first avatar or the second avatar.

The apparatus for publishing an avatar provided by the embodiments of the disclosure may perform the method of publishing an avatar provided by any embodiment of the disclosure, and has functional modules and beneficial effects corresponding to the method of publishing an avatar. For technical details not described in detail in the embodiment, reference may be made to the method of publishing an avatar provided by any embodiment of the disclosure.

Referring to Avatar 7 below, FIG. 7 is a schematic structural diagram of an electronic device (for example, a terminal device) 700 suitable for implementing the embodiments of the disclosure. The terminal device in the embodiments of the disclosure may include a mobile termina such a mobile phone, a notebook computer, a digital broadcast receiver, a personal digital assistant (PDA), a tablet computer (PAD), a portable multimedia player (PMP), a vehicle-mounted terminal (for example, an in-vehicle navigation terminal), and the like, and a fixed terminal such as a digital television (TV), a desktop computer, or the like. The electronic device shown in FIG. 7 is merely an example.

As shown in FIG. 7, the electronic device 700 may include a processing device (for example, a central processing unit, a graphics processor, etc.) 701, which may perform various appropriate actions and processing according to a program stored in a read-only memory (ROM) 702 or a program loaded into a random access memory (RAM) 703 from a storage device 708. In the RAM 703, various programs and data required by the operation of the electronic device 700 are also stored. The processing device 701, the ROM 702, and the RAM 703 are connected to each other through a bus 704. An input/output (I/O) interface 705 is also connected to the bus 704.

Generally, the following devices may be connected to the I/O interface 705: an input device 706 including, for example, a touch screen, a touch pad, a keyboard, a mouse, a camera, a microphone, an accelerometer, a gyroscope, etc.; an output device 707 including, for example, a liquid crystal display (LCD), a speaker, a vibrator, etc.; a storage device 708 including, for example, a magnetic tape, a hard disk, etc.; and a communication device 709. The communication device 709 may allow the electronic device 700 to communicate wirelessly or wired with other devices to exchange data. While FIG. 7 shows an electronic device 700 having various devices, it should be understood that it is not required to implement or have all illustrated devices. More or fewer devices may alternatively be implemented or provided.

In particular, according to an embodiment of the disclosure, the process described above with reference to the flowchart may be implemented as a computer software program. For example, embodiments of the disclosure include a computer program product comprising a computer program embodied on a non-transitory computer readable medium, the computer program comprising program code for performing the method shown in the flowchart. In such embodiments, the computer program may be downloaded and installed from the network through the communication device 709, or installed from the storage device 708, or from the ROM 702. When the computer program is executed by the processing apparatus 701, the foregoing functions in the method according to the embodiments of the disclosure are performed.

It should be noted that the computer-readable medium described above may be a computer readable signal medium, a computer readable storage medium, or any combination of the foregoing two. The computer-readable storage medium may be, for example, an electrical, magnetic, optical, electromagnetic, infrared, or semiconductor system, apparatus, or device, or any combination thereof. The computer-readable storage medium may include: an electrical connection having one or more wires, a portable computer diskette, a hard disk, a RAM, a ROM, an erasable programmable read-only memory (EPROM or Flash memory), an optical fiber, a portable compact disk read-only memory (CD-ROM), an optical storage device, a magnetic storage device, or any suitable combination thereof. In the disclosure, a computer-readable storage medium may be any tangible medium containing or storing a program that may be used by or in connection with an instruction execution system, apparatus, or device. In the disclosure, a computer readable signal medium may include a data signal propagated in baseband or as part of a carrier, where the computer readable program code is carried. Such propagated data signals may take a variety of forms, including electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including wires, optical cables, Radio Frequency (RF), and the like, or any suitable combination thereof.

In some implementations, the client, server may communicate using any currently known or future developed network protocol, such as HyperText Transfer Protocol (HTTP), and may be interconnected with any form or medium of digital data communication (e.g., a communication network). Examples of communication networks include Local Area Networks (LANs), Wide Area Networks (WANs), Internet networks (e.g., the Internet), and peer-to-peer networks (e.g., ad hoc peer-to-peer networks), as well as any currently known or future developed networks.

The computer-readable medium described above may be included in the electronic device described above; or may be separately present without being assembled into the electronic device.

The computer readable medium described above carries one or more programs, and when the one or more programs described above are executed by the electronic device, the electronic device is caused to: receive an avatar creation operation on a preset page, the preset page displaying a target object and a user identifier of at least one associated user of a current user; in response to the avatar creation operation, obtain a first avatar and a state of a target status identifier corresponding to the first avatar; receive an avatar publishing operation for the first avatar; and in response to the avatar publishing operation, publish the first avatar performing a target association action, wherein the target association action is an association action of the state of the target status identifier corresponding to the first avatar.

Computer program code for performing the operations of the disclosure may be written in one or more programming languages or combination thereof, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the avatars illustrate architecture, functionality, and operation of possible implementations of systems, methods, and computer program products according to various embodiments of the disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the avatars. For example, two consecutively represented blocks may actually be performed substantially in parallel, which may sometimes be performed in the reverse order, depending on the functionality involved. It is also noted that each block in the block diagrams and/or flowcharts, as well as combinations of blocks in diagrams and/or flowcharts, may be implemented with a dedicated hardware-based system that performs the specified functions or operations, or may be implemented in a combination of dedicated hardware and computer instructions.

The units involved in the embodiments of the disclosure may be implemented in software, or may be implemented in hardware. The name of the module may be set according to an actual situation in some cases.

The functions described above may be performed, at least in part, by one or more hardware logic components. For example, the exemplary types of hardware logic components that may be used include: a Field Programmable Gate Array (FPGA), an Application Specific Integrated Circuit (ASIC), an Application Specific Standard (ASSP), a System on Chip (SOC), a Complex Programming Logic Device (CPLD), and the like.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatus, or devices, or any suitable combination of the foregoing. The machine-readable storage medium may include an electrical connection based on one or more lines, a portable computer disk, a hard disk, a RAM, a ROM, an erasable programmable read-only memory (EPROM or Flash memory), an optical fiber, a CD-ROM, an optical storage device, a magnetic storage device, or any suitable combination of the foregoing.

According to one or more embodiments of the disclosure, an example 1 provides a method of publishing an avatar, including:
receiving an avatar creation operation on a preset page, the preset page displaying a target object and a user identifier of at least one associated user of a current user;
in response to the avatar creation operation, obtaining a first avatar and a state of a target status identifier corresponding to the first avatar;
receiving an avatar publishing operation for the first avatar; and
in response to the avatar publishing operation, publishing the first avatar performing a target association action, wherein the target association action is an association action of the state of the target status identifier corresponding to the first avatar.

According to one or more embodiments of the disclosure, the method of example 2 according to example 1, wherein the receiving an avatar creation operation on a preset page comprises:
receiving a trigger operation on the target object in the preset page;
in response to the trigger operation, displaying an avatar attribute setting interface; and
receiving a setting operation on the avatar attribute setting interface.

According to one or more embodiments of the disclosure, the method of example 3 according to example 2, wherein the state of the target status identifier comprises whether a target status identifier in a selected state exists, the displaying an avatar attribute setting interface comprises:
displaying a status setting page of the first avatar, wherein the status setting page comprises a status identifier display area, and at least one status identifier is displayed in the status identifier display area;
the receiving a setting operation on the avatar attribute setting interface comprises:
receiving a first setting operation for a target status identifier in the at least one status identifier, wherein the first setting operation is used to indicate to display the target status identifier as being in the selected state.

According to one or more embodiments of the disclosure, the method of example 4 according to example 4, the status setting page further comprises an action preview area, and the action preview area is configured to display a first preview picture of the target association action.

According to one or more embodiments of the disclosure, the method of example 5 according to example 2, the displaying an avatar attribute setting interface comprises:
displaying an avatar setting page;
the receiving a setting operation on the avatar attribute setting interface comprises:
receiving a second setting operation on the avatar setting page, wherein the second setting operation is used to indicate avatar information of the first avatar, and the avatar information comprises at least one of appearance information or clothing information.

According to one or more embodiments of the disclosure, the method of example 6 according to example 5, the avatar setting page comprises a first area, a second area and a third area, the first area is configured to display at least two first-level identifiers, the at least two first-level identifiers comprise a first-level avatar identifier and a first-level status setting identifier, the second area is configured to display second-level identifiers of the at least two first-level identifiers, the second-level identifiers of the at least two first-level identifiers comprise a second-level avatar identifier and a second-level status setting identifier, and the third area is configured to display an avatar list and a status identifier list, and after the displaying an avatar setting page, the method further comprises:
in response to a triggering operation for the target second-level status setting identifier displayed in the second area, displaying a status identifier list corresponding to a target second-level status setting identifier in the third area, and displaying the target second-level status setting identifier and the first-level status setting identifier corresponding to the target second-level status setting identifier as being in a selected state; or
in response to a trigger operation for the target second-level avatar identifier displayed in the second area, displaying an avatar list corresponding to a target second-level avatar identifier in the third area, and displaying the target second-level avatar identifier and the first-level avatar identifier corresponding to the target second-level avatar identifier as being in the selected state.

According to one or more embodiments of the disclosure, the method of example 7 according to example 6, after the displaying an avatar setting page, the method further comprises:
in response to the target sliding operation within the second area or the third area, switching an initial list displayed in the third area to a target list corresponding to a target sliding operation, and displaying a second-level identifier and a first-level identifier corresponding to the target list as a selected state;
wherein the initial list is the status identifier list, and the target list is the avatar list; or
the initial list is the avatar list, and the target list is the status identifier list.

According to one or more embodiments of the disclosure, the method of example 8 according to example 2, further comprising:
in response to a preview operation on the avatar attribute setting interface, switching a current page to a preview page, and displaying a second preview picture of target media content and a first publishing control in the preview page, wherein the first publishing control is configured to trigger the performing of the avatar publishing operation.

According to one or more embodiments of the disclosure, the method of example 9 according to example 8, wherein after the displaying a second preview picture of target media content and a first publishing control in the preview page, the method further comprises:
in response to a media content edition operation on the preview page, displaying an editing page of a target media content, wherein the editing page is configured to edit the target media content.

According to one or more embodiments of the disclosure, the method of example 10 according to example 9, wherein a second publishing control is displayed in the editing page, and the second publishing control is configured to trigger performing the avatar publishing operation.

According to one or more embodiments of the disclosure, the method of example 11 according to example 1, wherein the publishing the first avatar performing a target association action comprises:
displaying the first avatar published by the user in the target object of the preset page:

According to one or more embodiments of the disclosure, the method of example 12 according to example 1, wherein the in response to the avatar publishing operation, publishing the first avatar performing a target association action comprises:
in response to the avatar publishing operation, publishing a target media content and the first avatar performing the target association action.

According to one or more embodiments of the disclosure, the method of example 13 according to example 12, wherein the in response to the avatar publishing operation, publishing target media content and the first avatar performing the target association action comprises:
in response to a media content publishing operation for the first avatar, publishing the target media content and the first avatar performing the target association action, wherein the target media content displays a picture in which the first avatar performs the target association action.

According to one or more embodiments of the disclosure, the method of example 14 according to example 12 or 13, wherein background music of the target media content is background music associated with the first avatar.

According to one or more embodiments of the disclosure, the method of example 15 according to any of example 12, 13 or 14, wherein a picture background color of the target media content is a background color associated with the first avatar.

According to one or more embodiments of the disclosure, the method of example 16 according to any of example 1-13 wherein the publishing the first avatar performing a target association action comprises:
updating a profile picture of the current user with a first target profile picture displayed with the first virtual image.

According to one or more embodiments of the disclosure, the method of example 17 according to any of example 1-13, wherein after the publishing the first avatar performing a target association action, the method further comprises:
switching a current page to a preset page, and displaying at least one of the following in the preset page: the first avatar published by the current user and a user identifier of at least one associated user of the current user.

According to one or more embodiments of the disclosure, the method of example 18 according to any of example 1-13, further comprising:
in response to an update operation for the first avatar, updating a profile picture of the current user to a first target profile picture displayed with the first avatar.

According to one or more embodiments of the disclosure, the method of example 19 according to any of example 1-13, further comprising:
in response to a selection operation for a profile picture of the current user, updating a profile picture of the current user to a target profile picture, wherein the target profile picture comprises a first target profile picture displayed with the first avatar or a second target profile picture displayed with a non-avatar.

According to one or more embodiments of the disclosure, the method of example 20 according to any of example 1-13, wherein the user identifier of the associated user comprises a second target profile picture displayed with the second avatar or a third target profile picture displayed with a non-avatar, and the second avatar is an avatar set by the associated user.

According to one or more embodiments of the disclosure, the method of example 21 according example 20, wherein in the preset page, a display size of a profile picture displayed with an avatar is different from a display size of a profile picture displayed with a non-avatar, wherein the avatar comprises the first avatar or the second avatar.

According to one or more embodiments of the disclosure, an example 22 provides an apparatus for publishing an avatar, comprising:
a first receiving module, configured to receive an avatar creation operation on a preset page, the preset page displaying a target object and a user identifier of at least one associated user of a current user;
an obtaining module, configured to in response to the avatar creation operation, obtain a first avatar and a state of a target status identifier corresponding to the first avatar;
a second receiving module, configured to receive an avatar publishing operation of the first avatar; and
a publishing module, configured to in response to the avatar publishing operation, publish the first avatar performing a target association action, wherein the target association action is an association action of the state of the target status identifier corresponding to the first avatar.

According to one or more embodiments of the disclosure, an example 23 provides an electronic device, comprising:
one or more processors;
a memory, configured to store one or more programs, and
the one or more programs when executed by the one or more processors, cause one or more processors to implement the method of publishing an avatar according to any of examples 1-21.

According to one or more embodiments of the disclosure, an example 24 provides a computer-readable storage medium storing a computer program thereon, the program, when executed by a processor, implements the method of publishing an avatar according to any of examples 1-21.

Further, while operations are depicted in a particular order, this should not be understood to require that these operations be performed in the particular order shown or in sequential order. In certain circumstances, multitasking and parallel processing may be advantageous. Certain features described in the context of separate embodiments may also be implemented in combination in a single embodiment. Conversely, the various features described in the context of a single embodiment may also be implemented in multiple embodiments either individually or in any suitable sub-combination.

1-24. (canceled)

25. A method of publishing an avatar, comprising:
displaying a target object and a user identifier of at least one associated user of a current user;
in response to an avatar creation operation, obtaining a first avatar and a state of a target status identifier corresponding to the first avatar; and
in response to the avatar publishing operation, publishing the first avatar performing a target association action, wherein the target association action is an association action of the state of the target status identifier corresponding to the first avatar.

26. The method of claim 25, wherein the method further comprises:
receiving a trigger operation on the target object in a preset page;
in response to the trigger operation, displaying an avatar attribute setting interface; and
receiving a setting operation on the avatar attribute setting interface.

27. The method of claim 26, wherein the state of the target status identifier comprises whether a target status identifier in a selected state exists,
the displaying an avatar attribute setting interface comprises:
displaying a status setting page of the first avatar, wherein the status setting page comprises a status identifier display area, and at least one status identifier is displayed in the status identifier display area;
the receiving a setting operation on the avatar attribute setting interface comprises:
receiving a first setting operation for a target status identifier in the at least one status identifier, wherein the first setting operation is used to indicate to display the target status identifier as being in the selected state.

28. The method of claim 27, wherein the status setting page further comprises an action preview area, and the action preview area is configured to display a first preview picture of the target association action.

29. The method of claim 26, wherein the displaying an avatar attribute setting interface comprises:
displaying an avatar setting page;
the receiving a setting operation on the avatar attribute setting interface comprises:
receiving a second setting operation on the avatar setting page, wherein the second setting operation is used to indicate avatar information of the first avatar, and the avatar information comprises at least one of appearance information or clothing information.

30. The method of claim 29, wherein the avatar setting page comprises a first area, a second area and a third area, the first area is configured to display at least two first-level identifiers, the at least two first-level identifiers comprise a first-level avatar identifier and a first-level status setting identifier, the second area is configured to display second-level identifiers of the at least two first-level identifiers, the second-level identifiers of the at least two first-level identifiers comprise a second-level avatar identifier and a second-level status setting identifier, and the third area is configured to display an avatar list and a status identifier list, and
after the displaying an avatar setting page, the method further comprises:
in response to a triggering operation for the target second-level status setting identifier displayed in the second area, displaying a status identifier list corresponding to a target second-level status setting identifier in the third area, and displaying the target second-level status setting identifier and the first-level status setting identifier corresponding to the target second-level status setting identifier as being in a selected state; or
in response to a trigger operation for the target second-level avatar identifier displayed in the second area, displaying an avatar list corresponding to a target second-level avatar identifier in the third area, and displaying the target second-level avatar identifier and the first-level avatar identifier corresponding to the target second-level avatar identifier as being in the selected state.

31. The method of claim 30, wherein after the displaying an avatar setting page, the method further comprises:
in response to the target sliding operation within the second area or the third area, switching an initial list displayed in the third area to a target list corresponding to a target sliding operation, and displaying a second-level identifier and a first-level identifier corresponding to the target list as being in a selected state;
wherein the initial list is the status identifier list, and the target list is the avatar list; or
the initial list is the avatar list, and the target list is the status identifier list.

32. The method of claim 26, further comprising:
in response to a preview operation on the avatar attribute setting interface, switching a current page to a preview page, and displaying a second preview picture of target media content and a first publishing control in the preview page, wherein the first publishing control is configured to trigger the performing of the avatar publishing operation.

33. The method of claim 32, wherein after the displaying a second preview picture of target media content and a first publishing control in the preview page, the method further comprises:
in response to a media content edition operation on the preview page, displaying an editing page of a target media content, wherein the editing page is configured to edit the target media content.

34. The method of claim 25, wherein the publishing the first avatar performing a target association action comprises:
displaying the first avatar published by the user in the target object of the preset page.

35. The method of claim 25, wherein the in response to the avatar publishing operation, publishing the first avatar performing a target association action comprises:
in response to the avatar publishing operation, publishing a target media content and the first avatar performing the target association action.

36. The method of claim 35, wherein the in response to the avatar publishing operation, publishing a target media content and the first avatar performing the target association action comprises:
in response to a media content publishing operation for the first avatar, publishing the target media content and the first avatar performing the target association action, wherein the target media content displays a picture in which the first avatar performs the target association action.

37. The method of claim 35, wherein background music of the target media content is background music associated with the first avatar, and/or
wherein a picture background color of the target media content is a background color associated with the first avatar.

38. The method of claim 25, wherein the publishing the first virtual image performing a target association action comprises:
updating a profile picture of the current user with a first target profile picture displayed with the first virtual image.

39. The method of claim 25, wherein after the publishing the first avatar performing a target association action, the method further comprises:
switching a current page to a preset page, and displaying at least one of the following in the preset page: the first avatar published by the current user and a user identifier of at least one associated user of the current user.

40. The method of claim 25, further comprising:
in response to an update operation for the first avatar, updating a profile picture of the current user to a first target profile picture displayed with the first avatar.

41. The method of claim 25, further comprising:
in response to a selection operation for a profile picture of the current user, updating a profile picture of the current user to a target profile picture, wherein the target profile picture comprises a first target profile picture displayed with the first avatar or a second target profile picture displayed with a non-avatar.

42. The method of claim 25, wherein the user identifier of the associated user comprises a second target profile picture displayed with the second avatar or a third target profile picture displayed with a non-avatar, and the second avatar is an avatar set by the associated user, and/or
wherein in the preset page, a display size of a profile picture displayed with an avatar is different from a display size of a profile picture displayed with a non-avatar, wherein the avatar comprises the first avatar or the second avatar.

43. An electronic device, comprising:
at least one processor; and
a memory communicatively connected to the at least one processor, wherein
the memory stores a computer program executable by the at least one processor, and the computer program is executed by the at least one processor to cause the at least one processor to perform acts comprising:
displaying a target object and a user identifier of at least one associated user of a current user;
in response to an avatar creation operation, obtaining a first avatar and a state of a target status identifier corresponding to the first avatar; and
in response to the avatar publishing operation, publishing the first avatar performing a target association action, wherein the target association action is an association action of the state of the target status identifier corresponding to the first avatar.

44. A non-transitory computer-readable storage medium storing computer instructions, which, when executed by a processor, are configured to implement acts comprising:
displaying a target object and a user identifier of at least one associated user of a current user;
in response to an avatar creation operation, obtaining a first avatar and a state of a target status identifier corresponding to the first avatar; and
in response to the avatar publishing operation, publishing the first avatar performing a target association action, wherein the target association action is an association action of the state of the target status identifier corresponding to the first avatar.
